(19) United States
(12) Patent Application Publication
(10) Pub. No.: US 2008/0233393 A1
(43) Pub. Date: Sep. 25, 2008

(54) FILM TO ENCLOSE COMPOSITE STRUCTURES

(76) Inventor: Theodore Coburn, Coventry, RI (US)

Correspondence Address: CHRIS A. CASEIRO, VERRILL DANA, LLP, ONE PORTLAND SQUARE, PORTLAND, ME, 04112-0586, US

(21) Appl. No.: 12/053,286

(22) Filed: Mar. 21, 2008

Related U.S. Application Data
(60) Provisional application No. 60/896,407, filed on Mar. 22, 2007.

(51) Int. Cl. B32B 7/12; B29C 65/00

(52) U.S. Cl. 428/349; 156/60

(57) ABSTRACT

A multilayer film used to wrap composite structures under fabrication. The multilayer film includes a structural layer and an adhesion layer. The adhesion layer includes a composition formulated to cause the adhesion layer to soften and become tacky at temperatures associated with making the composite structure, while the structural layer includes a composition formulated to substantially maintain its structural characteristics at those temperatures. In the course of curing the composite structure, the structural layer maintains structural integrity while the adhesion layer acts to bond overlapping portions of the multilayer film together during the curing stage so as to minimize or eliminate the formation of gaps between adjacent pieces. The composition of the structural layer may include a slip additive to enable separation of the film from the composite structure after the curing stage. In one example, the composite structure is a golf club shaft under fabrication and the multilayer film is spiral wrapped around the composite structure.

### CROSS REFERENCE TO RELATED APPLICATION

The present application claims the priority benefit of U.S. provisional patent application Ser. No. 60/896,407, filed Mar. 22, 2007, entitled “FILM TO ENCLOSE COMPOSITE STRUCTURES” of the same named inventor. The entire contents of that prior application are incorporated herein by reference.

### BACKGROUND OF THE INVENTION

1. Field of the Invention

The present invention relates to films, tapes or sheets used to wrap or enclose composite structures under fabrication. Such films, tapes or sheets hereinafter referred to as “film” or “films.” More particularly, the present invention relates to films used to seal composite structures while resins therefore are cured in order to minimize resin loss during the curing stage. The present invention is directed to a co-extruded film capable of bonding to itself without bonding to the composite structure under fabrication.

2. Description of the Prior Art

A wide range of products are fabricated of composite structures. In general, these composite structures are formed by combining one or more fibrous materials with one or more resins. The fibers act to reinforce the resin and the resin acts to encapsulate the fibers. This synergistic combination provides a desirable substitute for other materials such as metal and wood. Specifically, composite structures may be formed in an array of shapes with tailorable characteristics related to flexibility, for example, while maintaining satisfactory strength.

One popular example of a composite structure replacing its metal and even wooden predecessors, is the golf shaft. The present invention is related to the process of fabricating golf shafts but is not limited thereto. Instead, the present invention is related to the fabrication of any type of composite structure involving the use of plastic film to aid in maintaining shape during the curing process. This type of film is particularly suited to the fabrication of tubular structures such as golf shafts, which are of varied cross-sectional dimensions through their lengths, which cross-sectional dimensions are small relative to the shaft length. It can be understood that other types of items may have similar structural characteristics including, for example, umbrella shafts. Fishing poles, tent poles and bicycle parts, and while the present invention is suitable for fabricating such structures, it is not limited thereto.

Generally stated, the process of fabricating a golf shaft involves the following basic steps. First, a basic form approximately the shape of the shaft to be fabricated is established. The form may be a model or mandrel, possibly covered by a release component, such as a treatment or a bladder. For a golf shaft, the form is generally cylindrical, with a varying diameter through the form's length such that the shaft to be fabricated will be tapered. One or more plies of fabric or fibers of selectable size and shape are manually or automatically wrapped around the form in a predetermined arrangement. A resin, such as an epoxy, is applied to the fabric or fibers on the form. Alternatively, the resin may be applied to the fabric or fibers, such as by immersion, prior to placement on the form. That combination, sometimes referred to as a “pre-preg” may optionally be pre-cured such as by heating the combination on the form.

Thereafter, a ply of adhesive is wrapped over the pre-cured layers of fabric/fiber and resin and a second set of the same or a similar cloth (or fabric) and resin combination may be placed over the adhesive layer. Finally, a non-metallic film is spiral wound (or spiral wrapped) around the entire combination in order to give the fabricated composite structure's outer surface a desired appearance and, more importantly, to enclose any liquefied material (such as the resin and/or the adhesive) and keep it in a uniform distribution about the form. The film-wrapped assembly is then placed in a mold or an oven and heated for a time sufficient to allow the resin to fully cure. Following this process, the part is removed from the mold or oven, the wrapping film is cut and removed from the part and discarded, and the exterior surface of the part sanded and finished as needed.

The film used to wrap the composite for the final curing process may be slit into narrow strips for spiral winding around the form. The film is typically made of cellophane, nylon or polypropylene. The cellophane will absorb water while stored, which is an undesirable characteristic. In addition, it may tear or propagate when in use. The polypropylene may also tear or propagate when in use. The tearing or propagation of the film wrap may result in resin loss prior to full cure. It may also cause severe surface variations on the cured composite, requiring extensive repair thereafter. Nylon is relatively expensive and therefore of limited interest in industry. Trico Industries of North Kingstown, R.I. has developed and offers a homopolymer film with high unidirectional strength suitable for the application of wrapping tubular composites under fabrication. The Trico film is available under the name Flexrite HS™ tensilized film.

The films presently used to enclose composite tubular structures under fabrication have an undesired limitation. The film strips should have minimal overlap in the course of winding, otherwise, the exterior of the structure would be unacceptably uneven. When the film strips are wound around the tubular form they must be wrapped in successive rows and with tension so that will remain substantially in place during the curing stage. However, that tensioned wrapping results in the creation of gaps between successive strips. Those gaps enable the resin to seep out, causing one or more bulges wherever the gaps exist. Those bulges must be repaired. They also represent a loss of resin where desired and, therefore, a potentially deficient structure. Attempts to resolve this problem include wrapping multiple layers of film around the form. This increases the cost of manufacture and may still not fully resolve the problem.

Therefore, what is needed is a polymeric film suitable for wrapping of tubular composite structures with few or no gaps between successive strips of the wrapping.

### SUMMARY OF THE INVENTION

It is an object of the present invention to provide a polymeric film suitable for wrapping, including spiral wrapping, of tubular composite structures with few or no gaps between successive portions of the wrapping. It is also an object of the present invention to provide a corresponding method for fabricating such a film. As used herein, a “portion” is any piece, strip, wrap, or section representing the film of the present invention in some desired configuration suitable for placement about the composite structure.

These and other objectives are achieved in the present invention, which is a multilayer film comprising a structural layer and an adhesion layer with release properties. The layers of the film may be co-extruded. The structural layer is formed of a polyolefin, such as polyethylene, polypropylene or a combination thereof. The structural layer is preferably formulated and processed to exhibit relatively high tensile strength with minimal shrinkage. The adhesion layer is sufficiently compatible with the structural layer to minimize separation of the two while in use. The adhesion layer is preferably formulated and processed to be tacky at temperatures less than the tackiness-generating temperature of the structural layer. The tackiness of the adhesion layer causes the film to stick to itself at composite structure curing temperatures. That combination of the characteristics of the two layers in a single film aids in reducing tension-producing gaps between successive wraps, including spiral wraps.

When used to enclose the exterior of a composite tubular form comprising fabric/resin, the multilayer film of the present invention is to be applied in a specific way. In particular, the structural layer side of the film is placed in contact with the composite form, with the adhesion layer spaced away from the form by the structural layer. As the film of the present invention is wound or otherwise wrapped around the composite, adjacent portions in contact with one another are subject to attachment to one another at the structural layer-adhesion layer interface, thereby minimizing slippage between those adjacent portions. Further, as the composite form is heated to cure the resin, the adhesion layers tend to flow. This provides for improved bonding of film portions adjacent to one another and thereby eliminates slippage that may occur in the course of placing the film about the fiber/resin composite and during the resin curing. At the same time, the composition of the structural layer minimizes bonding between the film and the composite as the structural layer does not have such adhesion characteristics. Further, the structural layer may be formed to include a slip additive to minimize bonding between the film and the composite. That feature ensures that the film may be easily separated from the composite upon completion of the curing phase.

The multilayer film of the present invention preferably includes as the structural layer a polyolefin compound such as the Trico Flexrite HS™ material to enable considerable tensioning during the wrapping phase without causing tearing. The multilayer film results in a more consistent tubular composite structure, with better control of the location of the break point (for a golf shaft), and less machining required after resin cure. Further, the multilayer film permits the composite structure manufacturer to use a single layer of film to achieve the same performance previously requiring multiple layers of film to ensure suitable enclosure with minimal gap formation. Moreover, establishing the adhesion layer on the exterior allows easier film removal after composite formation. These features result in a more cost effective process for composite structure production.

The details of one or more examples related to the invention are set forth in the accompanying drawings and the description below. Other features, objects, and advantages of the invention will be apparent from the description and accompanying drawings.

### BRIEF DESCRIPTION OF THE DRAWINGS

FIG. 1 is a simplified diagrammatic view of a film processing system of the present invention to fabricate a multilayer film of the present invention.

FIG. 2 is a simplified cross-sectional view of the multilayer film of the present invention.

FIG. 3 is a simplified side view of an example tubular composite structure with the multilayer film of the present invention applied thereto.

### DETAILED DESCRIPTION OF THE PREFERRED EMBODIMENT

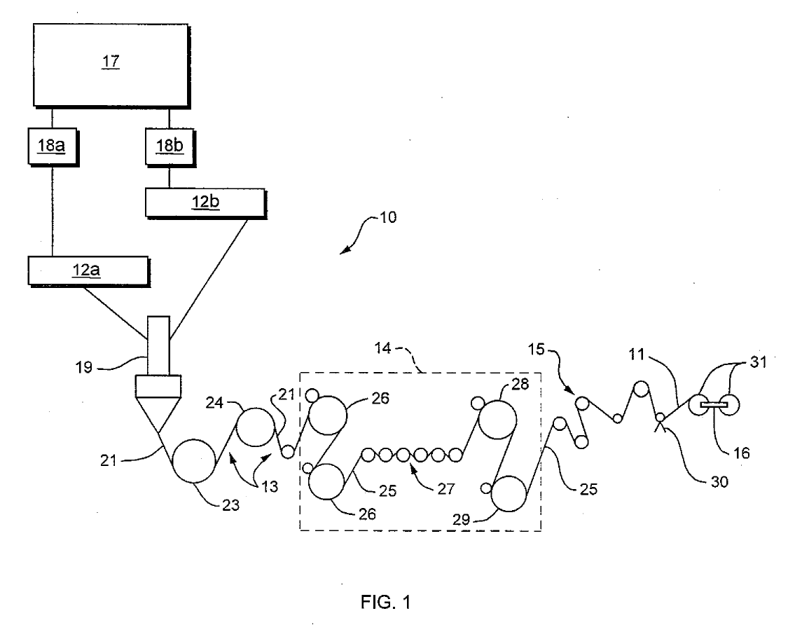

FIG. 1 shows a simplified diagrammatic view of a film fabrication system 10 used in the novel fabrication process of the present invention to create a novel multilayer film stock 11 having structural and adhesion characteristics. Primary components of the system 10 include a pair of extruders 12a and 12b, a multilayer roll unit 13, a film-orientation unit 14, a corona treatment unit 15, and an end-product winder 16. The extruders 12a and 12b are used to extrude individual layers of materials including individual components selected to provide desired characteristics of each layer. A primary component of any individual layer is a structural material that is preferably polypropylene but may be any selected from the group consisting of polyethylenes of various densities and/or molecular weights, polypropylenes, and copolymers of polyethylene and polypropylene. Other suitable materials as the primary component may include, but are not limited to, polyesters, polyvinyl chlorides, ethylene vinyl acetate, ethylene methacrylate, or other materials that may be of interest. In general, the components may be pelletized or in any form suitable for adequate mixing and extruding. It is noted that those skilled in the art will recognize that standard additives may be included in the mixtures of the layers of the multilayer film dependent upon the particular application. Such additives may be anti-blocks, anti-stats, slip additives and the like. It is of importance for the purpose of the present invention that one layer is distinct from the other, including one primarily with structural characteristics and the other with adhesion characteristics.

Components may be delivered via tubes of a component material blender 17 into individual mixing hoppers 18a and 18b, one set of feeder and hopper may be used for each of the extruders 12a and 12b; however, in some cases, the same feeder may be used to supply more than one extruder, or multiple feeders may supply a lesser number of extruders. All of the selected components for a particular layer are then transferred from the hopper 18a and/or hopper 18b into the extruders 12a and 12b for mixing at a selected temperature prior to transfer to a co-extrusion block and die 19. The extruders 12a and 12b and the co-extrusion block and die 19 can be of any type known to those skilled in the art to be suitable for mixing and extruding components of the type described herein. The co-extrusion block and die 19 directs the respective separately mixed outputs from extruders 12a and 12b into a single co-extruded film that is multi layer extrusion 21.

The multilayer extrusion 21 is transferred from the co-extrusion block and die 19 to a first casting chiller roll 23 of the multilayer roll unit 13. The multilayer extrusion 21 may be in a range of thicknesses when first reaching the roll 23, dependent upon the ultimate function of the multilayer stock 11 to be produced. For example, the extrusion 21 may be approximately, but is not limited to, 5-40 mils thick as it moves to the first casting chiller roll 23. The extrusion 21 moves from the first chiller roll 23 to a second casting chiller roll 24. Rolls 23 and 24 may be of any suitable temperature, but preferably about 100° F. This chilling of the extrusion 21 acts to solidify it into a film-like material. From the second chiller roll 24, the extrusion 21 is delivered to the film-orientation unit 14.

In the orientation unit 14, the extrusion 21 is stretched and may be oriented into a film 25 that can range in thickness from about 1-10 mils, but can be thinner or thicker than that range, again, dependent upon the desired function of the stock 11. A pre-heater pair of rollers 26 at a temperature of about 200°-270° F. warms and softens the extrusion 21 after the chill casting stage of the process. A series of stretching rollers 27 at a temperature of about 240° F. act to considerably increase the length of the film 25. That step thins the film 25 and will also create a unidirectional molecular orientation that provides increased strength and stiffness in the film 25. It is possible to provide the stock 11 without this specific stretching step; however, the resultant film may have less strength, stiffness, and clarity than that developed during stretching.

In the next stage of the process, orientation heat setting and then stress-relieving or relaxing of the film 25 occurs as it is transferred to a series of heat-stabilization rollers represented by roller 28. For the purpose of the present invention, the heat-stabilization rollers alternate between relative heating and cooling of the film. Specifically, a first one of theses rollers may be at a temperature in the range of about 270° F. to about 295° F. This imparts better stiffness and flatness in the end product. The next of the heat-stabilization rollers in the series is relatively cooler at a temperature of about 230° F. or less. This ensures that the adhesion layer of the film 25 will not melt too much and thereby minimize the effectiveness of the film 25. This arrangement of the heat-stabilization rollers 28 continues alternating for as many in the series deemed to be suitable for the desired end product. Thereafter, the film 25 is unstressed as it moves across a cooling roller 29 that may be at ambient temperature. The heat-stabilization rollers may have individual drive controllers between two or more individual rollers so as to control the speed of the film 25 passing therethrough. This is important to maintain the flow of the product through the continuous process.

From the orientation unit 14, the film 25 moves to the optional corona-treatment unit 15 where the film surface may be enhanced, such as for improved printability. Final processing of the film 25 may include cutting of rough film edges by a slitter 30. Scraps of the film 25 from the slitting process may be returned for re-introduction into the process and subsequent use. The final stock 11 is then wound onto transfer rolls 31 of the winder unit 16 for delivery to users. It is to be noted that the film suitable for the purpose of wrapping a composite structure is generally desired to have high tensile (uniaxial) strength. However, if it is desired to impart cross-wise (bi-directional) strength orientation of the film 25, it may be further stretched by applying the film 25 or stock 11 to a tenter frame and heating in an oven (not shown). Additionally, it is optionally preferable to heat stabilize the finished film 25 product after stretching it. Alternatively, a blown film system known by those skilled in the art of the field of the present invention may be used to provide enhanced bi-directional strength of the stock 11 as an alternative to the extrusion system shown.

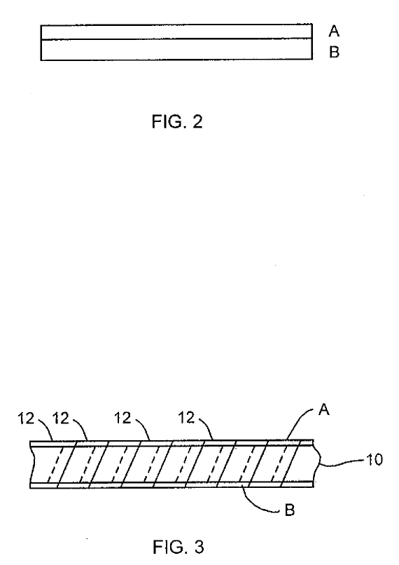

As illustrated in FIG. 2, an example of a stock 11 formed by the process of the present invention into a film, includes two individual layers, identified as Layer A and Layer B. Layer A is formed of a mixture including a polypropylene base and a slip additive to enhance the likelihood that Layer A will separate from the composite structure after resin curing. A slip additive suitable for this purpose is the Ampacet™ low-density base slip product #10061 available from the Ampacet Company located in Tarrytown, N.Y. Those skilled in the art will recognize that other slip additives may be suitable substitutes. The amount of slip additive to include in the mixture is dependent upon the desired required tension to separate Layer A from the composite structure after resin curing. Layer A may be formed by adding the identified components and any others of interest including, but not limited to, coloring, to hopper 18a, for example, and extruding it through extruder 12a for example.

Layer B is formed of a mixture including a base that may be of the same composition as that of the base of Layer A. In this example, the base of Layer B is preferably polypropylene. In addition, the mixture for Layer B includes a compound including vinyl acetate, which is a relatively soft material that softens at a temperature lower than the softening temperature of the base material. The mixture for Layer B may include optional components including, for example, a printable additive such as the printable additive described in U.S. Pat. No. 6,136,439 entitled “Monolayer Polymeric Film And Method Of Fabrication” issued on Oct. 24, 2000, and U.S. Pat. No. 6,703,447 entitled “High Bi-directional Strength Monolayer Polymeric Film And Method Of Fabrication” issued Mar. 9, 2004. Both patents are in the name of the inventor of the present invention. The entire contents of both referenced patents are incorporated herein by reference. Layer B may be formed by adding the identified components to hopper 18b, for example, and extruding it through extruder 12b for example. Layer A and Layer B are separately mixed and extruded to maintain their independent characteristics. They are then layered one on top of the other and die cast through the co-extrusion block and die 19.

The combination of Layer A and Layer B through the stock formation process described with reference to FIG. 1, or other suitable film/sheet fabrication process, yields a film with a first layer that provides structural integrity to the film, and a second layer that provides the sealing advantage that is desirable in the wrapping of a tubular composite structure, including such a structure with a varying diameter. In one example of a preferred composition of the structural layer identified as Layer A and the adhesion layer identified as Layer B in the simplified representation of FIG. 2, the structural layer is formed of a composition including about 89% by weight of a homopolymer such as polyethylene or polypropylene, about 9% by weight of an ethylene vinyl acetate containing a relatively low concentration of vinyl acetate therein, such as about 18% by weight vinyl acetate, and about 2% by weight of a slip additive such as the Ampacet™ product previously identified. The slip additive is preferably selected to be a late-blooming material such that it will not adversely affect any of the rollers identified with respect to FIG. 1. This composition makes for a mono-oriented pliable film having high tensile strength that further exhibits enough substantially uniform shrinkage through its thickness at low structure forming temperatures to tighten about the fiber/resin composite to aid in the structure's formation, but not so much shrinkage at higher processing temperatures that it fails or separates.

With continuing reference to the preferred example including the structural layer composition described in the preceding paragraph, the adhesion layer in this preferred composition of the film is formed of a composition of about 35% by weight of the same homopolymer used in the structural layer (to enhance compatible bonding of the two layers), about 63% by weight of an ethylene vinyl acetate containing a relatively high concentration of vinyl acetate, such as about 28% vinyl acetate, and about 2% of the noted slip additive. This composition is relatively tacky when the film is wound on the composite structure form, quite tacky when the composite form is being cured at temperature and of reduced tackiness when the form is cooled down.

As illustrated in FIG. 3, a multilayer film of the present invention may be used to enclose a composite structure under fabrication. The structure shown in FIG. 3 is a golf club shaft. It is to be understood that the present invention is not limited solely to such a tubular structure. A form tube 10 prepared in a way described in the Background is positioned such that previously slit portions 12 of the film including Layers A and B may be spirally wrapped thereon. The form 10 includes carbon fibers and an epoxy resin but is not limited thereto. The structural integrity of the film, particularly in the length direction, allows the composite structure manufacturer to wind the multilayer film relatively tightly. Further, the portions 12 are wrapped such that the structural layer, Layer A, is placed in contact with the fiber/resin combination, thereby positioning the adhesion layer, Layer B, on the outside of the entire combination of the fiber/resin with the film so that the film seals on itself during the resin curing process without bonding the film itself to the fiber/resin combination. The multilayer film is fabricated so that the film shrinks substantially uniformly through its thickness and in doing so acts to squeeze the composite structure to aid in the forming process. Upon cooling, the slip additive in the structural layer aids in easily skiving and removing the film from the cured composite structure and the cooled adhesion layer is of reduced tackiness, further aiding in the ease of removal of the film strips 12.

Those skilled in the art will see that a variety of compositions may be employed to create the structural layer and the adhesion layer based on an arrangement of a structural layer suitable to maintain the structural integrity of the film during the spiral wrapping process and through the cure stage, and an adhesion layer that is sufficiently tacky, particularly during the curing stage, to seal upon itself and thereby minimize gaps between film strips.

While the example multilayer film shown in FIGS. 2 and 3 represent the individual layers as being of substantially equal thickness, the layers may not be of equal thickness. For example but in no way intending to be limiting, Layer A of FIG. 2 may be formed much thicker than Layer B, such that Layer B may be used to carry Layer A through the process represented with regard to FIG. 1. It is to be understood that the example multilayer combination described herein is but a representation of options for the arrangement of the multilayer film of the present invention suitable for use in enclosing composite structures under fabrication. This description is not intended to limit the principle concept of the present invention. All equivalents are deemed to fall within the scope of this description of the invention as described by the following claims.

What is claimed is:

1. A multilayer film comprising:
a. a structural layer of a first composition including a first polymeric material; and
b. an adhesion layer of a second composition including a second polymeric material, wherein the structural layer is formulated and processed to substantially maintain its structural and surface characteristics at temperatures that cause the adhesion layer to soften and become tacky such that overlapping portions of the multilayer film adhere to one another.

2. The multilayer film of claim 1 wherein the first composition includes a slip additive.

3. The multilayer film of claim 2 wherein the quantity of slip additive added to the first composition is selected based upon the amount of desired force required to separate the multilayer film from a substrate to which it is applied.

4. The multilayer film of claim 1 wherein the first polymeric material and the second polymeric material are the same.

5. The multilayer film of claim 4 wherein the first polymeric material and the second polymeric material are polypropylene.

6. The multilayer film of claim 1 wherein the structural layer is formulated and processed to exhibit higher tensile strength than the adhesion layer.

7. The multilayer film of claim 1 wherein the structural layer and the adhesion layer are formulated such that shrinkage through the thickness of the multilayer film is substantially uniform.

8. The multilayer film of claim 1 wherein the second composition is formulated to be sufficiently compatible with the first composition to minimize delamination of the adhesion layer from the structural layer.

9. The multilayer film of claim 1 wherein the first composition and the second composition include vinyl acetate and wherein the concentration of vinyl acetate in the second composition is higher than the concentration of vinyl acetate in the first composition.

10. A method of fabricating a composite structure including a resin, the method comprising the steps of:
a. forming a desired shape of the composite structure;
b. applying a multilayer film to the exterior surface of the composite structure, wherein the multilayer film includes a structural layer of a first composition including a first polymeric material, and an adhesion layer of a second composition including a second polymeric material, wherein the structural layer is formulated and processed to substantially maintain its structural and surface characteristics at a resin curing temperature and the adhesion layer is formulated and processed to soften and become tacky at the resin curing temperature such that overlapping portions of the multilayer film adhere to one another; and
c. curing the resin of the composite structure at the resin curing temperature.

11. The method of claim 10 wherein the step of applying the multilayer film includes the step of applying the structural layer of the multilayer film directly to the composite structure such that the adhesion layer is spaced from the composite structure by the structural layer.

12. The method of claim 10 further comprising the step of removing the multilayer film from the composite structure, wherein the first composition of the structural layer is formulated to enable separation of the multilayer film from the composite structure.

13. The method of claim 12 wherein the first composition includes a slip additive.

14. The method of claim 10 wherein the composite structure is a golf club shaft, further comprising the step of spiral wrapping the multilayer film around the golf club shaft.

15. The method of claim 10 wherein the first polymeric material and the second polymeric material are the same.

16. The method of claim 15 wherein the first polymeric material and the second polymeric material are polypropylene.

17. The method of claim 10 wherein the second composition is formulated to be sufficiently compatible with the first composition to minimize delamination of the adhesion layer from the structural layer.
